(19) United States
(12) Patent Application Publication
(10) Pub. No.: US 2026/0324701 A1
(43) Pub. Date: Oct. 22, 2026

(54) FRUIT PROCESSING DEVICE

(71) Applicant: JBT Marel Corporation, Chicago, IL (US)

(72) Inventors: Philip G. Hebbler, Warman (CA); Christopher W. Roberts, Winter Haven, FL (US); David S. Danner, Tampa, FL (US); Brandon R. Coles, Tampa, FL (US)

(73) Assignee: JBT Marel Corporation, Chicago, IL (US)

(21) Appl. No.: 19/647,650

(22) Filed: Apr. 14, 2026

Related U.S. Application Data
(60) Provisional application No. 63/790,251, filed on Apr. 17, 2025.

(51) Int. Cl. A23N 7/08

(52) U.S. Cl. CPC A23N 7/08

(57) ABSTRACT

A fruit processing apparatus includes an in-feed system for delivering fruit to be processed to a slicer that slices the fruit into two halves including through the pit. Thereafter, the pit is removed with a plunger tool that removes the pit half with the minimal damage to the pulp and without transferring the husk or peel into the pulp. Next the husk or peel is removed from the pulp at a peeler apparatus employing counter rotating rollers. The roller pinch and lift the entire peel or skin or husk from the pulp as a unit so as to maximize yield of the pulp solids and without contaminating the pulp with the peel or skin or husk.

### CROSS-REFERENCE TO RELATED APPLICATION

This application claims the benefit of U.S. Provisional Application No. 63/790,251, filed Apr. 17, 2025, the entire contents of which are incorporated herein by reference.

### BACKGROUND

Currently, avocados and other “soft” fruit are processed manually where the corresponding pulp is required to remain substantially intact. Not only is this a time-consuming, labor intensive process, but it is also becoming difficult and quite costly to attract workers who desire to perform this type of manual, repetitive work. Drum or roller squeeze systems currently exist that are capable of processing the avocado pulp into a paste or puree product. This processing method is not suitable where retaining chunks or solids content is required. For the US guacamole market, 30% solids or greater content is required by customers; for Asian markets, 50% or greater solids content is required.

Avocado peelers exist for peeling the husk of the fruit, but do not split, pit, or dice or cut the fruit. These machines are semiautomatic and too slow to be cost effective for large-scale fruit processors.

Thus, there is an immediate industry need for an automated system and ‘substantially solid form. Moreover, it is desirable that the processing system be able to accommodate various size fruit with various pit sizes, without having to change machine components while processing the fruit, with minimal damage to the pulp, and with minimal pulp loss. The system and method of the present disclosure seek to achieve these results.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In accordance with one embodiment of the present disclosure, an apparatus is provided for processing fruit having a pulp disposed within a husk and a pit disposed in the pulp. The apparatus includes spaced apart contoured gripping surfaces converging toward each other to receive and hold a fruit there between for cutting the fruit through the pit into two halves while held by the gripping surfaces.

In any of the embodiments described herein, the apparatus may include a cutting device for cutting the fruit through the pit into two halves.

In any of the embodiments described herein, the apparatus may include a sensor for sensing at least one physical parameter of the fruit half related to the location of the pit in the fruit half. Thereafter an ejector may be used for ejecting the pit from the fruit half based on the sensed at least one physical parameter of the fruit half.

In any of the embodiments described herein, wherein the gripping surfaces are configured to define a groove to receive the fruit therein.

In any of the embodiments described herein, wherein the gripping surfaces each comprising two sections, the two sections forming complementary sections of the receiving groove.

In any of the embodiments described herein, wherein the two sections of the gripping surfaces are spaced apart from each other.

In any of the embodiments described herein, wherein the gripping surfaces move in a circular path.

In any of the embodiments described herein, wherein the gripping surfaces are defined by the outer perimeter portion of a rotary wheel assembly.

In any of the embodiments described herein, wherein the wheel assembly comprising two spaced apart wheel structures.

In any of the embodiments described herein, wherein each wheel structure comprising a rim section and a gripping surface section detachable mounted to the rim section.

In any of the embodiments described herein, wherein gripping surface section is detachably mounted on the rim section at selective locations relative to the outer perimeter of the rim section to alter the diameter of the gripping surface section.

In any of the embodiments described herein, wherein the rotary wheel assembly comprising a rim structure and a gripping surface structure.

In any of the embodiments described herein, wherein the gripping surface structure is detachably mounted on the rim structure at selective locations relative to the outer perimeter of the rim structure to alter the diameter of the gripping surface structure.

In any of the embodiments described herein, wherein the cutting device selected from the group consisting of a water jet, a rotating saw, a reciprocal saw, a knife, a rotating knife, an ultra-sonic saw.

In any of the embodiments described herein, further comprising a roller apparatus for engaging the husk to remove the husk from the pulp.

In any of the embodiments described herein, wherein the roller apparatus comprising counter-rotating rollers that engage the husk to remove the husk from the pulp.

In any of the embodiments described herein, wherein the rollers have textured outer surfaces to grip the husk.

In any of the embodiments described herein, wherein the texture outer surfaces are selected from the group consisting of; longitudinal ridges, straight longitudinal ridges; intermittent longitudinal ridges; spiral ridges; intermittent spiral ridges; teeth; pointed teeth, canted teeth, curved teeth.

In any of the embodiments described herein, further comprising a support surface spaced apart from the rollers for supporting the fruit during removal of the husk by the rollers.

In any of the embodiments described herein, wherein the support surface is relatively movable toward and away from the rollers.

In any of the embodiments described herein, wherein the rollers are longitudinal in configuration to rotate about a respective longitudinal axis, with the fruit advancing toward the rollers for removal of the husk.

In any of the embodiments described herein, further comprising a support surface spaced apart from the rollers for supporting the fruit during advancing toward the rollers and removal of the husk by the rollers.

In any of the embodiments described herein, wherein the support surface is angled relative to the rollers to reduce the distance between the support surface and the rollers as the fruit advances towards the rollers.

In any of the embodiments described herein, wherein the angle of the support surface relative to the rollers is selectively variable.

In any of the embodiments described herein, wherein the support surface is movable relatively toward and away from the at least two rollers.

In any of the embodiments described herein, wherein the sensor sensing the height of the fruit relative to the support surface, and the distance separating the support surface from the rollers is automatically adjusted accordingly.

In any of the embodiments described herein, wherein the distance separating the rollers is selectively variable.

In any of the embodiments described herein, wherein the respective longitudinal axes of the rollers are disposed at an angle relative to each other.

In any of the embodiments described herein,, wherein the relative angle of the longitudinal axes of the rollers can be selectively variable.

In any of the embodiments described herein, wherein the outer surfaces of the rollers are contoured to grip the husk.

In any of the embodiments described herein, wherein the contoured outer surfaces are selected from the group consisting of: longitudinal ridges, straight longitudinal ridges; intermittent longitudinal ridges; spiral ridges; intermittent spiral ridges; teeth; pointed teeth, curved teeth, canted teeth.

In accordance with an embodiment of the present disclosure, an apparatus is provided for processing fruit having a pulp disposed within a husk and a pit disposed in the pulp. The apparatus includes spaced apart contoured gripping surfaces converging toward each other to receive and hold a fruit there between while the fruit is cut through the pit into two halves while held by the gripping surfaces.

In any of the embodiments described herein, wherein an ejector may be used for ejecting the pit from the fruit half.

In any of the embodiments described herein, wherein a roller apparatus may be used for engaging the husk to remove the husk from the pulp.

In any of the embodiments described herein, wherein the roller apparatus comprising at least two counter-rotating rollers that engage the husk to remove the husk from the pulp.

In any of the embodiments described herein, wherein the rollers have textured outer surfaces to grip the husk.

In any of the embodiments described herein, wherein the texture outer surfaces are selected from the group consisting of; longitudinal ridges, straight longitudinal ridges; intermittent longitudinal ridges; spiral ridges; intermittent spiral ridges; teeth; pointed teeth, curved teeth; canted teeth.

In any of the embodiments described herein, further comprising a support surface spaced apart from the at least two rollers for supporting the fruit during removal of the husk by the rollers.

In any of the embodiments described herein, wherein the support surface is relatively movable toward and away from the at least two rollers.

In any of the embodiments described herein, wherein the rollers are longitudinal in configuration to rotate about a respective longitudinal axis, with the fruit advancing relatively toward the rollers for removal of the husk.

In any of the embodiments described herein, further comprising a support surface spaced apart from the rollers for supporting the fruit during relative advancement toward the rollers.

In any of the embodiments described herein, wherein the support surface is angled relative to the rollers to reduce the distance between the support surface and the rollers as the fruit relatively advances towards the rollers.

In any of the embodiments described herein, wherein the angle of the support surface relative to the rollers is selectively variable.

In any of the embodiments described herein, wherein the support surface is movable toward and away from the rollers.

In any of the embodiments described herein, further comprising a sensor for sensing the height of the fruit relative to the support surface; and wherein the distance between the support surface and the rollers is automatically adjusted based on the sensed height of the fruit.

In any of the embodiments described herein, wherein the distance separating the rollers is selectively variable.

In any of the embodiments described herein, wherein the respective longitudinal axes of the rollers are disposed at an angle relative to each other.

In any of the embodiments described herein, wherein the relative angle of the longitudinal axes of the rollers can be selectively variable.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a pictorial view of the fruit processing machine of the present disclosure taken for above and to one side of the machine;

FIG. 2 is a side elevational view of FIG. 1;

FIG. 3 is a view similar to FIG. 2, but with parts removed to show some of the internal construction of the machine;

FIG. 4 is a fragmentary pictorial view of a portion of the machine of FIG. 1;

FIG. 5 is an enlarged fragmentary view of the construction of a wheel structure;

FIG. 6 an enlarged fragmentary view of the construction of a wheel gripping structure segment;

FIG. 7 is a cross-sectional view of a possible embodiment of the gripping structure segment of FIG. 6;

FIG. 8 is an enlarged fragmentary view of FIG. 3 showing the slicing blade;

FIG. 9 is an enlarged fragmentary view of FIG. 3 showing a sensor for sensing a physical parameter of the fruit being processed;

FIG. 10 is an enlarged fragmentary view of FIG. 3 showing an embodiment of a pit removal tool;

FIG. 11 is a top view of FIG. 10;

FIG. 12 is an enlarged fragmentary view of FIG. 3 showing another embodiment of a pit removal tool;

FIG. 13 is an enlarged fragmentary view of FIG. 3 showing another embodiment of a pit removal tool;

FIG. 14 is an enlarged fragmentary view of FIG. 3 showing another embodiment of a pit removal tool;

FIG. 15 is an enlarged fragmentary view of FIG. 3 showing the travel of the fruit between the pit removal tool and the peeler apparatus for removal of the husk;

FIG. 16 is an enlarged fragmentary view of FIG. 3 showing the peeler apparatus;

FIG. 17 is an enlarged fragmentary view showing the peeler apparatus acting on the fruit being processed;

FIG. 18 is an end view of FIG. 17 showing the fruit after removal of the husk;

FIG. 19 is an enlarged fragmentary view of FIG. 3 showing the fruits with the husk removed by the peeler apparatus;

FIG. 20 is an enlarged side view showing another example of the movement of the peeling rollers of the peeler apparatus;

FIG. 21 is an enlarged pictorial view showing another example of the relative movement of the peeling rollers of the peeler apparatus;

FIG. 22 is enlarged pictorial view showing one embodiment of a peeling roller;

FIGS. 23A, 23B and 23C are pictorial, side elevational and end views of another embodiment of a peeling roller;

FIGS. 24A, 24B, and 24C are pictorial, side elevational and end views of another embodiment of a peeling roller;

FIGS. 25A, 25B, and 25C are pictorial, side elevational and end views of another embodiment of a peeling roller; and

FIG. 26 is an enlarged top view of peeling rollers acting to align the fruit being processed.

### DETAILED DESCRIPTION

In the following description and in the accompanying drawing, corresponding systems, assemblies, apparatus, and units may be identified by the same part number, but with an alpha suffix. The descriptions of the parts/components of such systems assemblies, apparatus, and units that are the same or similar are not repeated so as to avoid redundancy in the present application.

The description set forth below in connection with the appended drawings, where like numerals reference like elements, is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the disclosure to the precise forms disclosed. Similarly, any steps described herein may be interchangeable with other steps, or combinations of steps, in order to achieve the same or substantially similar result.

In the following description, numerous specific details are set forth in order to provide a thorough understanding of exemplary embodiments of the present disclosure. It will be apparent to one skilled in the art, however, that many embodiments of the present disclosure may be practiced without some or all of the specific details. In some instances, well known process steps have not been described in detail in order not to unnecessarily obscure various aspects of the present disclosure. Further, it will be appreciated that embodiments of the present disclosure may employ any combination of features described herein.

The present application may include references to “directions,” such as “forward,” “rearward,” “front,” “back,” “ahead,” “behind,” “upward,” “downward,” “above,” “below,” “horizontal,” “vertical,” “top,” “bottom,” “right hand,” “left hand,” “in,” “out,” “extended,” “advanced,” “retracted,” “proximal,” and “distal.” These references and other similar references in the present application are only to assist in helping describe and understand the present disclosure and are not intended to limit the present invention to these directions.

The present application may include modifiers such as the words “generally,” “approximately,” “about,” or “substantially.” These are meant to serve as modifiers to indicate that the “dimension,” “shape,” “temperature,” “time,” or other physical parameter in question need not be exact, but instead may vary as long as the function that is required to be performed can be carried out. For example, in the phrase “generally circular in shape,” the shape need not be exactly circular as long as the required function of the structure in question can be carried out.

The system and method of the present disclosure can also be used with other types of fruits and vegetables beyond avocados. For example, the system and method of the present disclosure can also be used with plums, cherries, peaches, nectarines, and olives.

Such fruit includes an outer husk, skin or peel that covers and protects the pulp or meat of the fruit. Such fruit also includes a pit or seed within the pulp or meat.

Further the system and method of the present invention can be used beyond the extraction of pits or stones from fruits and vegetables. For example, the system and method of the present disclosure can be used to remove seeds, pips, woody content, or other unwanted content within fruits or vegetables, including holding the fruit or vegetable while removing seeds, pips, woody content, or other unwanted content.

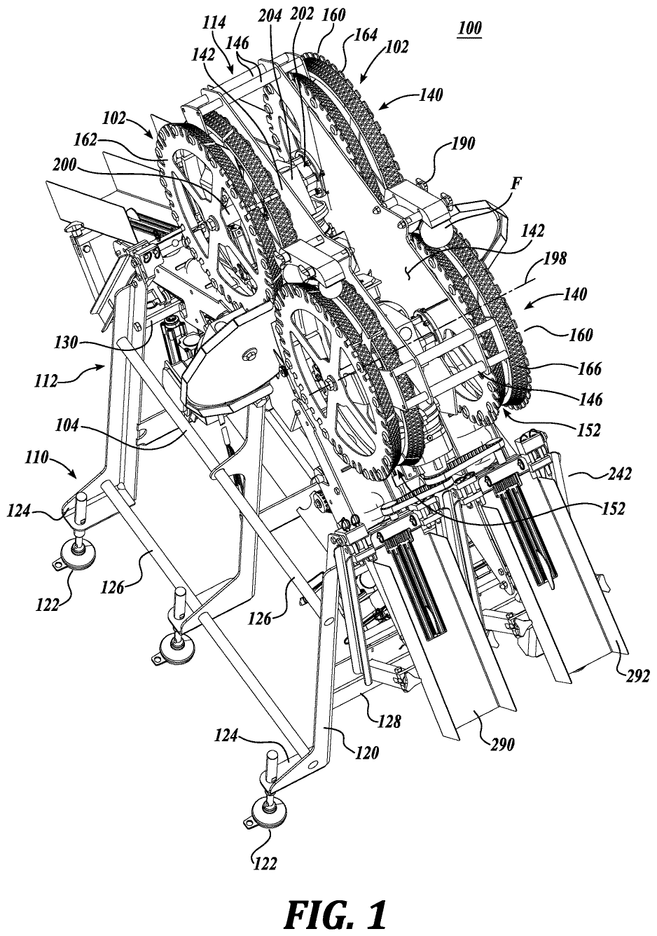

A fruit processing apparatus 100 is disclosed in FIGS. 1-4 as including, in basic form, an in-feed system 102 for delivering fruit F to be processed to a slicer 104 that slices the fruit into two halves H including through the pit P. Thereafter, the pit is removed with a plunger tool 106 that removes the pit half with the minimal damage to the pulp and without transferring the husk or peel into the pulp. Next, the husk or peel is removed from the pulp at a peeler apparatus 242 by the use of counter rotating rollers 206A and 206B. The roller pinch and lift the entire peel or skin or husk from the pulp as a unit so as to maximize yield of the pulp solids and without contaminating the pulp with the peel or skin or husk. It is to be understood that the apparatus 100 need not include all of these components nor the process need include all of these steps.

Next describing the apparatus 100 in greater detail, referring initially to FIGS. 1-3, the apparatus 100 is mounted on a frame 110 composed basically of a lower base structure 112 that supports an upper structure 114. As shown in the figures, the base structure 112 is of open construction thereby providing convenient access to the components of the apparatus 100 for cleaning, servicing, repairing and for other purposes.

In this regard the base structure 112, in one form of the present disclosure may include three upright, spaced apart formed legs 120 positioned along each side of the base structure. Vertically adjustable feet 122 are attached to the base section 124 of each of the legs 120 to conveniently adjust the height of the apparatus 100 as well as to perform a leveling function.

The three legs 120 on each side of the base structure 112 are connected together by longitudinal connecting rods 126 at the base of the legs as well as at an additional location toward the top of the legs. In addition, the legs 120 on each side the base structure 112 are connected to the legs 120 on the opposite side of the base structure by cross connectors. In this regard, a formed cross plate 128 interconnects the lower sections of the end legs 120. In addition, a cross rod 130 interconnects the upper sections of the end legs 120.

Of course, other means can be used to brace the legs 120, as well as to construct the base structure 112 itself.

The upper structure 114 of the frame 110 is designed to support four wheel assemblies 140 that grip and feed the fruit F past the slicer 104. The wheel assemblies 140 are mounted for powered rotation on longitudinally extending and spaced apart parallel upright frame plates 142 that extend upwardly from the frame base structure 112. The upper ends of the frame plates 142 are held in spaced apart relationship to each other by cross rods 146.

The wheel assemblies 140 are arranged in two cooperating sets, with a set located along each side on the frame 110. The wheel assemblies 140 of each set are positioned to be substantially tangential to each other, with a small gap separating the wheel assemblies of each set to provide clearance for the blade 150 of the slicer 104 that is disposed transversely to and between the wheel assemblies, as discussed below.

The wheel assemblies 140 are configured to receive the fruit F and feed the fruit past the slicing blade 150 in correct orientation and position so that the slicing blade cuts through the fruit pit P. In this regard, The outer perimeter of each wheel assembly 140 may be contoured to define a depression or groove 152 for receiving the fruit F therein and indexing the fruit to be disposed substantially along the length of the perimeter of the wheel assembly.

To help grip the fruit F, the outer perimeter of the wheel assembly 140 maybe textured to increase the friction between the outer perimeter and the fruit. Also, the outer perimeter of the wheel assembly may be composed of a material that enhances the “grip” between the wheel assembly and the fruit. Further, the outer perimeter of the wheel assembly maybe composed of a resilient material that compresses slightly when pressed against the fruit.

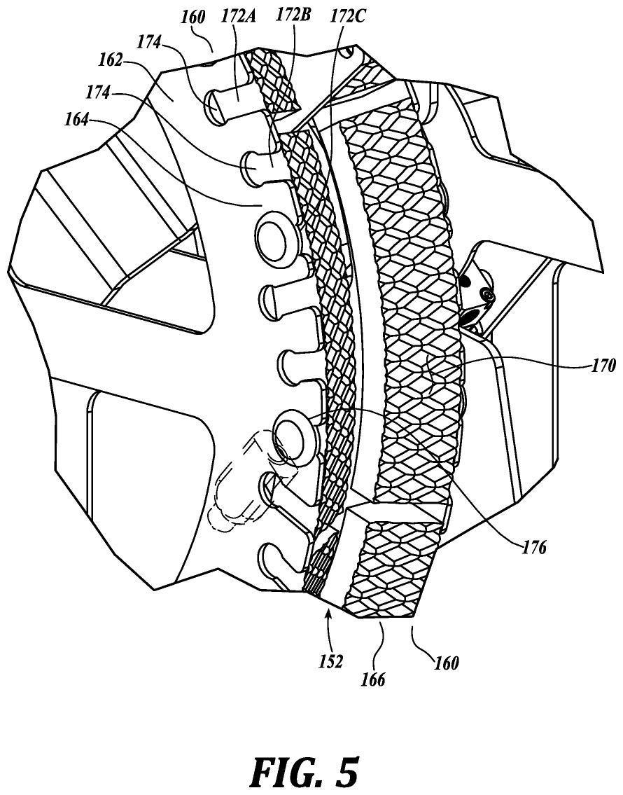

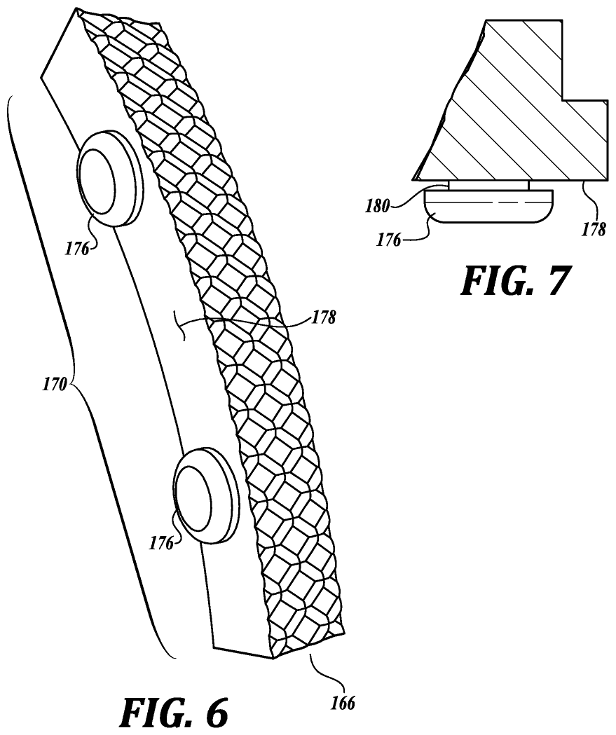

Additionally referring to FIGS. 5 and 6, in one form of the present disclosure the wheel assemblies 140 may be composed of two side by side wheel structures 160. Each of the wheel structures 160 includes an outer face plate 162 that defines a perimeter rim portion 164 to which is mounted a gripping structure 166. The face plate maybe relatively thin in comparison to the thickness of the gripping structure 166.

As shown in FIGS. 1, 4, and 5, the gripping structure 166 slopes diametrically inwardly from the faceplate 162 relative the axis of rotation 198 of the wheel structures 160. In this manner, the gripping structure 166 forms the depression or groove 152 for receiving and holding the fruit F. As discussed above, the outer surface of the gripping structure 166 maybe textured to increase the friction with the fruit. Also, the gripping structure 166, or at least the outer surface thereof, may be composed of a material that enhances the “grip” between the wheel gripping and the fruit.

Further, at least the outer surface of the gripping structure 166 maybe composed of a resilient material that compresses slightly when pressed against the fruit. Such material may be of various compositions, including for example, silicon natural or synthetic rubber, or foamed natural or synthetic rubber.

The wheel assemblies 140 are configured to accommodate various sizes of fruit. In this regard the gripping structure 166 is formed in arcuate segments 170. Each of the segments 170 maybe mounted to the perimeter rim portion 164 of the face plates 162 at a plurality of locations relative to the outer perimeter of the face plates and thus relative to the rotational axis 198 of the wheel assemblies 140.

In this regard three sets of radial receiving slots 172A, 172B, and 172C are repeatedly formed in the perimeter rim portion 164 of the face plates 162. These receiving slots are open in the radially outward direction. Radially inwardly, the receiving slots bottom at a slightly enlarged rounded head section 174.

As shown in FIG. 6, each of the gripping structure segments 170 include at least two mounting buttons 176 that extend from the side surface 178 of the gripping structure segment. The buttons 176 are space a short distance from the side surface 178 by a shank portion 180 having a diameter slightly larger than the width of the receiving slots 172A, 172B and 172C, but closely corresponding to the size of the rounded head section 174. In this regard, the gripping structure segments 170 maybe mounted to the perimeter rim portion 164 by sliding the shank portions 180 downwardly into the applicable slots 172A, 172B, or 172C. When the shank portion 180 reaches the head section 174, the shank portion expands to its nominal size and is thereby locked in place within the applicable slot.

It will be appreciated by the foregoing construction that the overall diameter of the gripping structure 166 can be adjusted to match the size of the fruit F being processed. In this regard, for large fruit the gripping structure segments 170 can be engaged with the deepest slots 172A. Correspondingly, for midsize fruit the gripping structure segments 170 can be engaged with the intermediate depth slots 172B, and for small size fruit the gripping structure segments 170 can be engaged with the shortest depth slots 172C.

It is to be understood that a greater number or a fewer number of receiving slots 172 may be utilized, and the slots may be of different lengths than shown in the figures. Also, the length of the gripping structure segments 170 may be selectively chosen based on various factors, including, for example, the diameter of the wheel assemblies 140 and the material composition of the gripping structure segments,

As shown in FIGS. 1-4, the fruit F to be processed can be presented to the upper perimeter portion one of the wheel assemblies 140 by an appropriate delivery system, optimally with the fruit disposed lengthwise to the perimeter of the wheel assembly. Such fruit is maintained within the groove 152 defined by the gripping structure 166 by a guide 190 spaced above the outer perimeter of the gripping structure. The guide 190 retains the fruit in the groove 152 until the fruit has traveled sufficiently to also be engaged by the griping structure of the corresponding wheel assembly. The height that the guide is positioned above the applicable gripping structure can be adjusted based on the size of the fruit being processed.

It will be appreciated that curved underside of the guide 190 helps retain the fruit within the groove 152 defined by the gripping structure 166, and also can be helpful in maintaining the orientation of oblong fruit lengthwise within the groove 152 so as to be positioned in alignment with the outer perimeter of the groove 152.

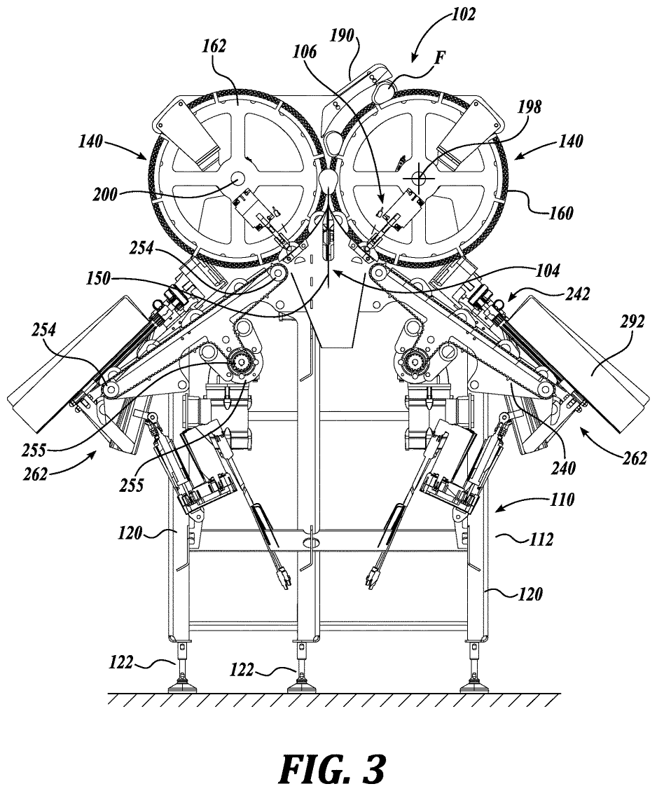

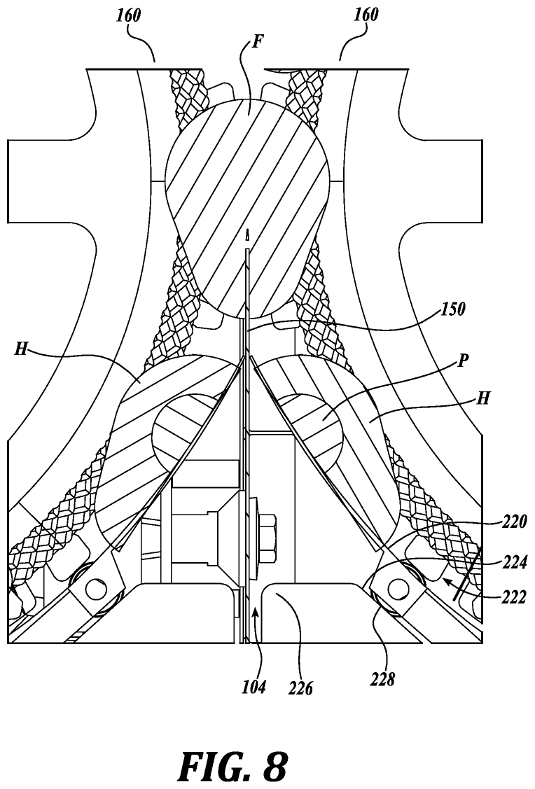

Once the fruit F travels along the receiving wheel assembly 140 a distance far enough to be in contact with the opposite receiving wheel assembly 140 of the set, the fruit then becomes sufficiently gripped by the two corresponding wheel assemblies so as to be securely held in fixed position while continuing to travel toward and through the cutting blade 150. Further, the cooperative action of the gripping structures 166 of the two-wheel assemblies 140 on the exterior of the fruit functions to align the oblong fruit to be disposed longitudinally relative to the length of the groove 152, as shown in FIGS. 3 and 8.

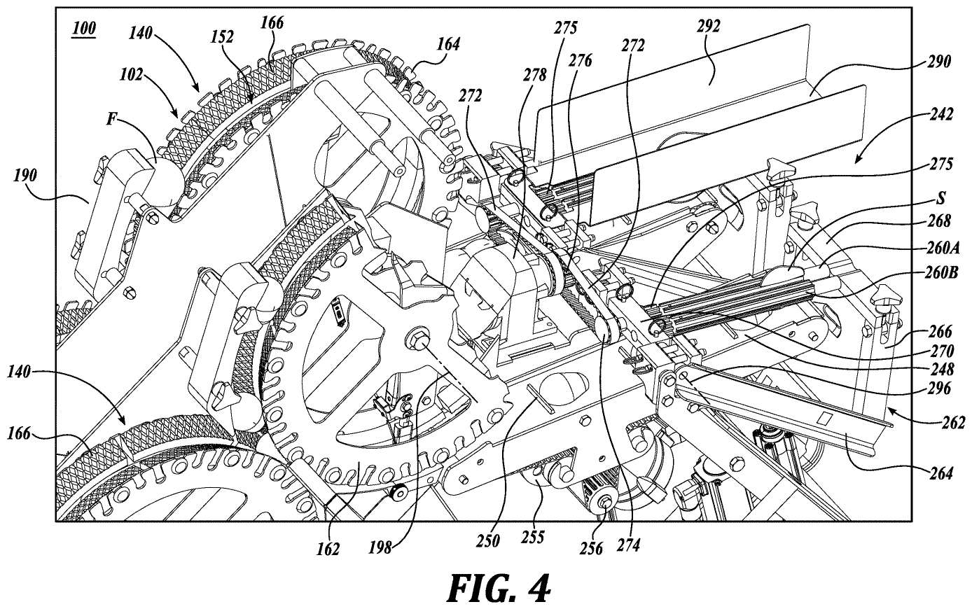

As shown in FIGS. 1 and 4, two sets of side-by-side wheel assemblies 140 are mounted on the frame 110 to process two lines of fruit at the same time. The same type of fruit may be processed in the two lines, or each line may be processing a different type of fruit. Further, different size ranges of the same fruit may be processed in the two lines.

As noted above, the wheel assemblies 140 can be adjusted to feed different size fruit to the slicer 104. And as discussed below, the operation of the plunger tool 106 can be controlled based on the size of the fruit. As also discussed below, the operation of the peeler apparatus 242 can be controlled to accommodate fruit of different sizes.

Two side-by-side wheel assemblies 140 are rotated about the common axis 198 by a drive axle 200 extending outwardly from the opposite sides of a gear box 202. The gear box 202 is in turn powered by a drive motor 204 positioned between the two wheel assemblies 140 being driven. Rather than driving the two side-by-side wheel assemblies 140 in tandem by a single drive axle, each of the wheel assemblies can be individually driven.

Referring to FIGS. 3 and 8, the circular cutting blade 150 of the slicer 104 may be disposed perpendicularly to the wheel assembles 140 to be located in the narrow gap that separates the wheel assemblies. The top of the outer perimeter of the blade 150 is approximately at the height of the rotational axis 198 of wheel assemblies 140. The slicer, powered by a motor 210 mounted on the frame 110 alongside the slicer, cuts through the fruit F, including the pit P, to form two fruit halves H.

Rather than being in the form of the circular blade 150, the slicer 104 can be other configurations. For example, the slicer can be in the form of a water jet, a reciprocal saw, a knife, a rotating knife, an ultra-sonic saw, a laser blade, etc.

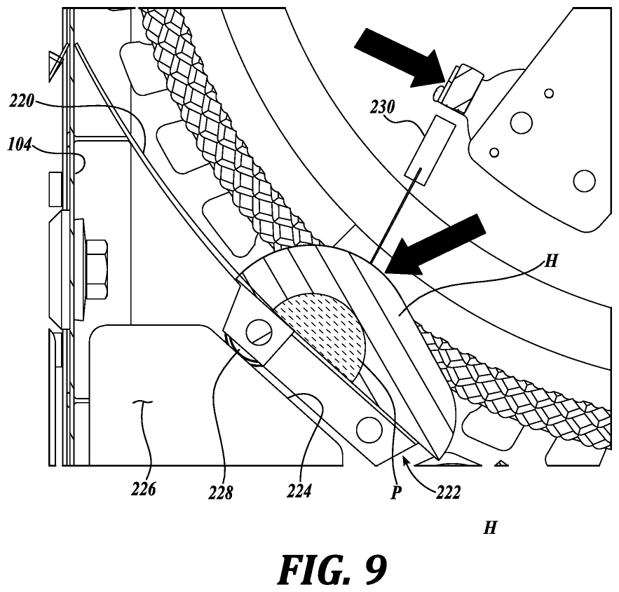

Referring to FIGS. 8 and 9, the sliced fruit halves H are advanced along a curved support surface 220 by the rotation of the wheel structures 160. The support surface 220 is part of a formed structure 222 that is supported by an inclined surface 224 of a frame member 226. A roller 228 is axled to the structure 222 for support of the structure 222 relative to the wheel structures 160.

As shown in FIG. 9, the advancing fruit half H can be routed to pass by a sensor 230 that senses the height of the fruit half. Typically, the pit P of a fruit F is located at largest portion or maximum size location of the fruit. As shown in FIG. 9 in the fruit half H, the pit P corresponds to the maximum height or diameter location of the fruit.

Other physical aspects of the fruit may be sensed in lieu of or in addition to the height of the fruit half. For instance, the location where the outer curvature of the fruit is at an apex can be sensed. As another alternative, the midpoint along the length of the fruit could be sensed.

Various types of sensors can be employed to ascertain the height of the fruit half H. For example, an optical sensor, a light beam sensor, a laser sensor, a sonar sensor, a lidar sensor, or other type of sensor may be employed. The sensor 230 may be mounted on the frame 110 by any appropriate means.

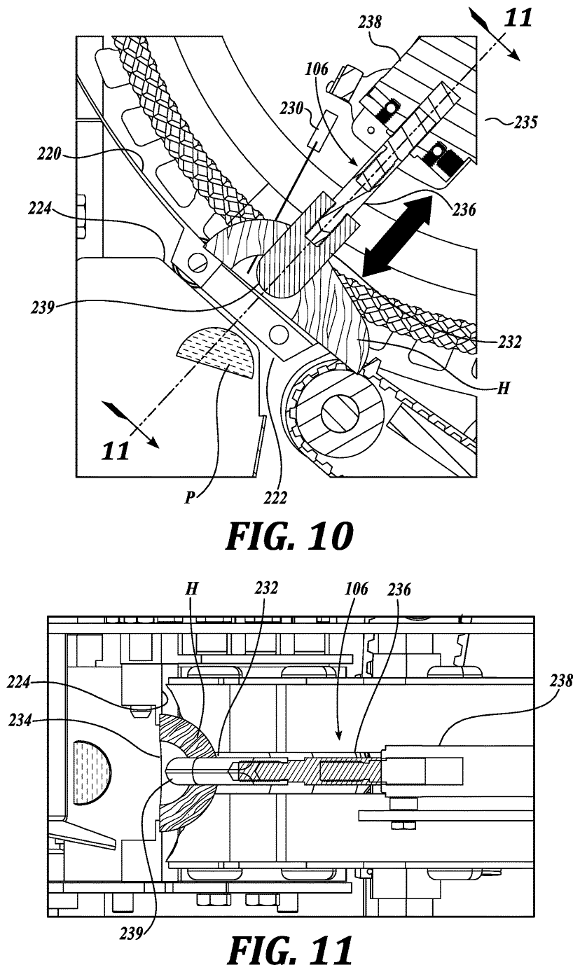

Referring additionally to FIGS. 10-14, the plunger tool 106 can be used to remove the pit P from the fruit half H. The plunger tool 106 is located downstream from the sensor 230, and employs the information from the sensor to determine when to advance a plunger head 232 into the fruit half H to push the pit P from the fruit half and through a longitudinal gap 234 formed in the inclined surface 224. The removed pit P falls downwardly away from the inclined surface 224 and may be collected, for example, in a bin or other receptacle.

The plunger tool 106 may be in the form of a linear actuator 235 composed of a rod or shank 236 that extends from and retracts relative to a body portion 238 of the linear actuator 235. The plunger head 232 is mounted on the distal end portion of the shank 236 to pierce through the husk or skin of the fruit F and the pulp to press against the pit P and force the pit out of the fruit half H.

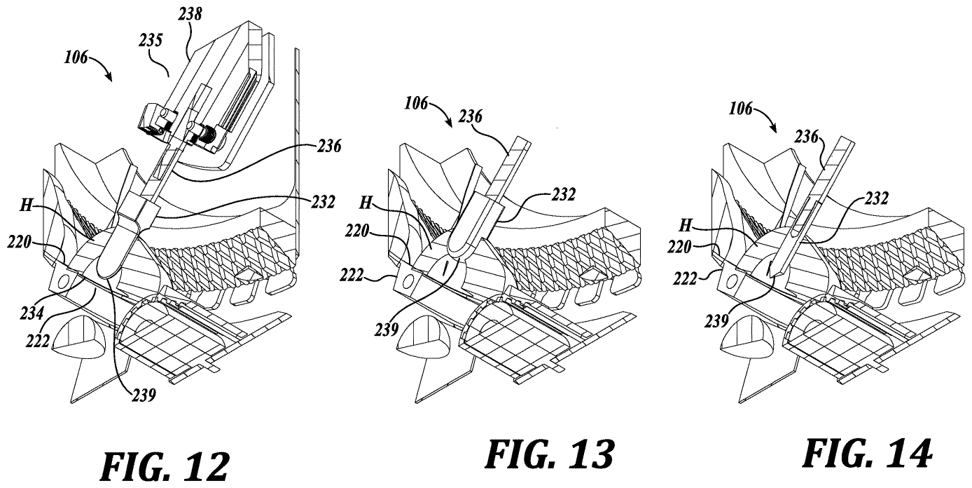

The plunger head 232 can take various forms as shown in FIGS. 10-14. For example, in FIGS. 10 and 11 the plunger head 232 is in the form of a semi spherical tip 239. In the example shown in FIG. 12, the plunger head 232 is in the form of a relatively thin blade having a rounded tip 239. As a further example, in FIG. 13 the plunger head 232 is thicker than shown in FIG. 12 but also with a rounded tip 239. As another example, in FIG. 14 the plunger head 232 has a V shaped tip 239.

All of the different tip configurations of the plunger head 232 are designed to remove the pit P from the fruit half H without embedding the husk or skin of the fruit into the pulp. In this regard, other configurations of the plunger head also can be used. For example, a roller can be mounted on the distal end of the shank 236 to depress the husk or skin as well as the adjacent portion of the pulp toward the pit P and thereby eject the pit from the fruit half H without the roller engaging into the pulp, but rather remaining external to the husk or skin. Of course, this function can be carried out even if the plunger head is in other configurations in addition to being in the form of a roller.

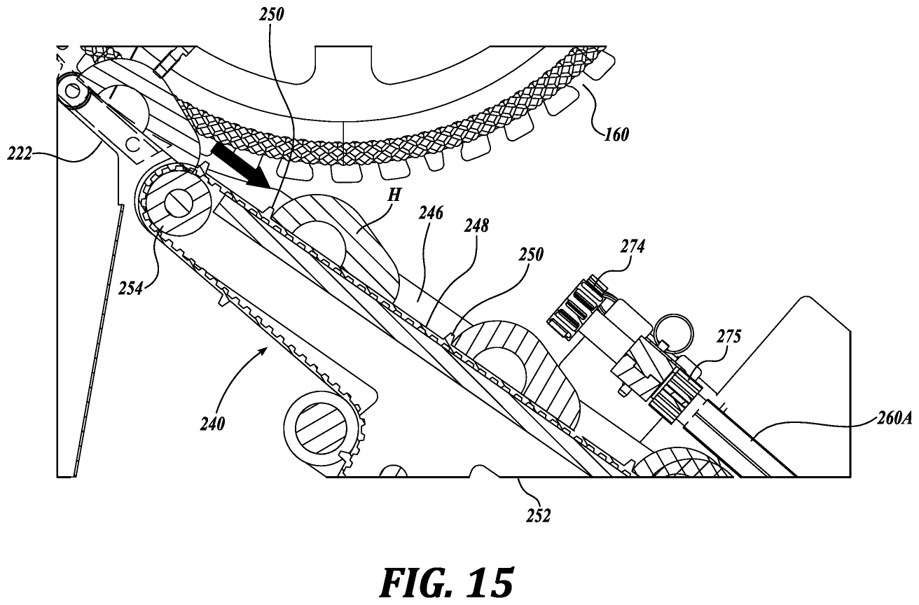

Once the pit P has been removed, the fruit half H can proceed along the apparatus 100 for removal of the husk or skin from the pulp. Referring to FIG. 15, the fruit in the form of pitted avocado halves is advanced by the wheel structures 160 from the support surface 220 to engage a powered conveyor 240 to be carried to a peeler apparatus 242 for removal of the husk or skin.

In this regard, the powered conveyor 240 includes a belt 246 having on upper run 248 that is disposed at an incline corresponding to the slope of the distal end of the support service 220, so as to constitute a continuation of the path for the fruit half H.

Transverse ridges 250 may extend across the upper surface of the belt upper run 240 to push against the adjacent portion of the fruit half H to keep the fruit half in position on the belt 246. The ridges also help prevent the fruit half for sliding down the belt by providing a stop for the front of the fruit half. The ridges 250 may be incorporated into the structure of the belt 246 or maybe added to the belt structure.

The conveyor 240 is mounted on a frame structure which can include an inclined frame 252 which in turn is mounted on frame base structure 112. The belt 246 trains around end rollers 254 axled to the ends of the inclined frame 252. The belt 246 is driven by a drive roller 256 located between the end rollers 254. The drive roller is in turn powered by a motor 255 or other type of rotational actuator. The motor of 255 may be electrically, hydraulically or pneumatically powered or powered by other means.

The drive roller 256 may include cogs that engage corresponding ridges formed in the underside of the belt 246 in a standard manner. Of course, the drive roller the 256 and the belt 246 may be of other constructions known in the art.

Idler rollers 258 are mounted on the frame 252 to provide sufficient wrap of the belt 246 around the drive roller 256. One or both of the idler rollers 258 maybe mounted on a rotatable arm and resiliently loaded against the belt 246 so that the belt is sufficiently tensioned. Of course, the belt 246 can be tensioned by other means.

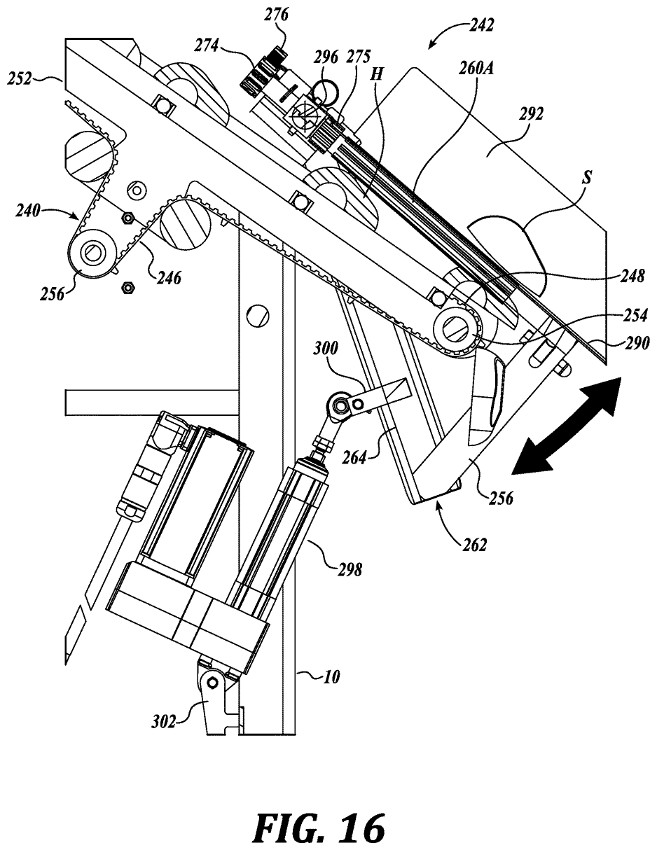

As noted above the conveyor 240 advances the pitted fruit halves H into engagement with a appealer apparatus 242 for removal of the husk from the pulp of the fruit. In one form of the present disclosure, the peeler apparatus 242 can include at least 2 counter rotating peeling rollers 260A and 260B disposed above the conveyor 240 by a frame structure 262. See FIGS. 4 and 16.

The frame structure 262 can include spaced apart side arms 264 having proximal ends pivotally mounted to the apparatus frame 110. The distal ends of the side arms 264 extend forwardly and relatively downwardly with respect to the distal end of the conveyor 240. End arms 266 extend from the distal ends of the sidearms generally transversely to the conveyor 240 to intersect the ends of an across arm 268.

The cross arm 268 supports the distal ends of the peeling rollers 260A and 260B that are illustrated as being of elongated configuration. The proximal ends of the rollers 260A and 260B are axled for rotation by a crossbar 270 mounted on the frame 262.

The peeling rollers 260A and 260B are powered for counter rotation by a drive belt 272 which engages a driven roller 274 mounted on an extended end of the peeling roller 260B. Gears 275 are mounted on or incorporated into the proximal ends of the peeling rollers 260A and 260B to cause counter rotation of the peeling rollers.

Opposite the driven roller 274, the drive belt 272 engages a drive roller 276 which is in turn powered by a motor 278. The motor 278 drives the drive rollers 276 on both sides of the apparatus 100. The motor 278 may be electrically, hydraulically or pneumatically powered or powered by other means.

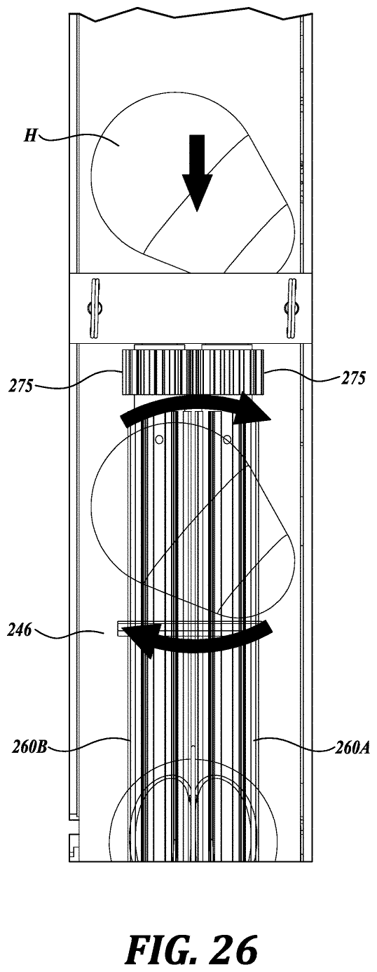

As shown in FIG. 16, the frame structure 262 can be positioned so that the distance between the underside of the peeling rollers 260A and 260B and the top or carrying surface of the conveyor 240 decreases in the longitudinal direction of the peeling rollers and the conveyor so that skin or husk of the fruit makes gradual engagement with the peeling rollers. This gradual engagement causes the peeling rollers 260A and 260B to position elongate fruit so that it is longitudinally in alignment with the rotational axis of the peeling rollers. See also FIG. 26.

As the fruit further engages the peeling rollers 260A and 260B, the peeling rollers pinch and grasp the skin S of the fruit between the two rollers and cause the skin to be pulled and separated from the pulp. The separated skin is ejected upwardly through the narrow gap between the two peeling rollers 260A and 260 B. See, for example, FIGS. 4 and 16. The pulp continues along the conveyor belt 246 to fall off the end of the conveyor belt 246 for collection and perhaps further processing.

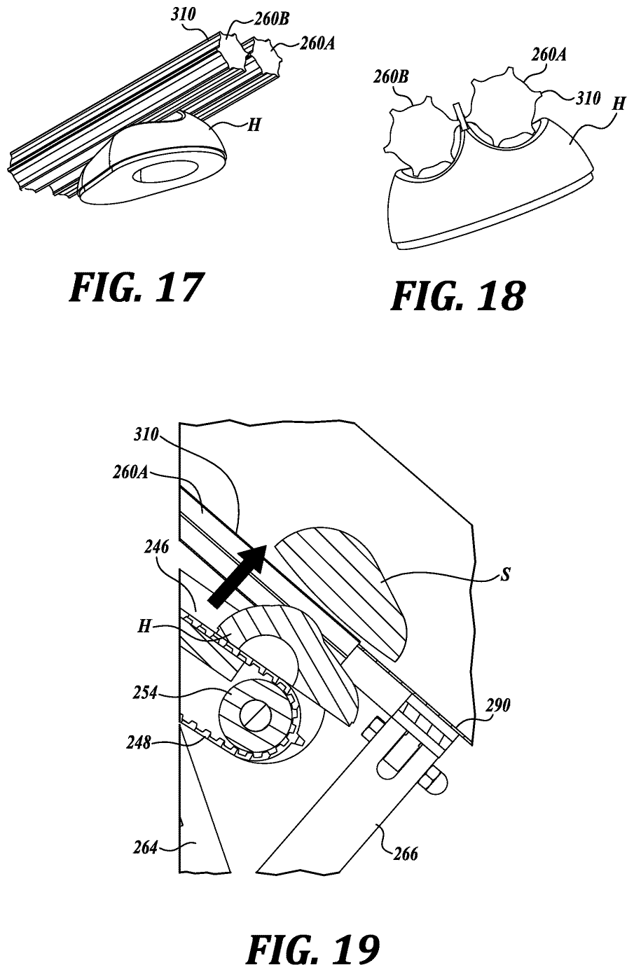

As shown in FIGS. 17 and 18, the action of the peeling rollers 260A and 260B causes slight depressions in the top portion of the pulp. For fruit such as avocados, such depressions are acceptable and do not detract from the use of the avocados.

The removed skin S slides down a ramp 290 for collection. The ramp 290 has the central cut out to receive the peeling rollers 260A and 260B therein. Also, sidewalls 292 can extend along the sides of the ramp 290 to constrain the removed skin or husk on the ramp.

As shown in FIGS. 16 and 19, applicant has found that for optimal skin or husk removal, with minimal effect on the pulp, the spacing between the underside of the peeling rollers 260A and 260B and the conveyor belt 246 is such that the skin at the top of the fruit is fully engaged by the peeling rollers when the fruit is at or near the distal end of the conveyor belt. This enables the skin or husk to be effectively removed from the pulp with minimal depression of the pulp by the peeling rollers.

To enable the foregoing optimal spacing between the underside of the peeling rollers 260A and 260B and the conveyor belt 246, the height of the peeling rollers above the conveyor belt can be adjusted for each piece of fruit F being processed. One exemplary way to accomplish this spacing adjustment is to pivotally mount the frame structure 262 on the frame 100, for example, as shown in FIGS. 4 and 16.

As shown in FIGS. 4 and 16, the frame structure 262 can be mounted on the frame 100 about rotational axis 296. The position of the frame structure 262 about the rotational axis 296 can be controlled by a linear actuator 298. The distal end of the actuator 298 is pivotally attached to a bracket 300 attached to the sidearm 264 of the frame structure 262. The opposite or proximal end of the linear actuator 298 is pivotally attached to the frame base structure 112 by a second bracket 302. The linear actuator may be electrically, hydraulically or pneumatically powered or powered by other means.

It will be appreciated that by this construction, the distance separating the underside of the peeling rollers 260A and 260B from the conveyor belt 246 maybe conveniently automatically adjusted for the size or other parameter of each of the fruit F being processed. The information required to make this adjustment can be the same as, or derived from, the sensor 230, discussed above. Or, a further sensor can be employed sense the height or other parameter of the fruit approaching the peeler apparatus 242.

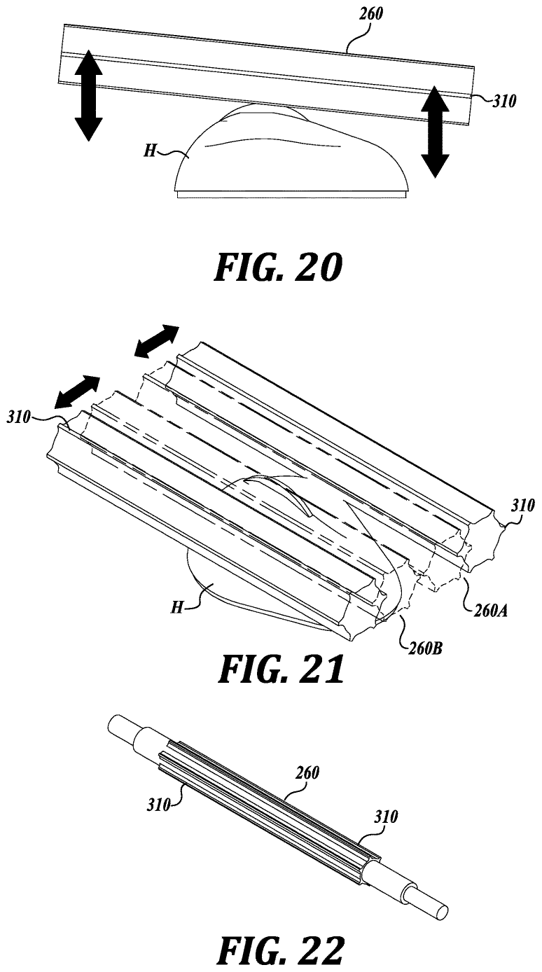

In lieu of, or in addition to, mounting the peeling rollers 260A and 260B so that their distal ends may be moved closer to for further from the conveyor belt 246, the peeling rollers can be mounted so the entire lengths of the peeling rollers can be move closer to or further from the conveyor belt 246 as a unit. This is schematically shown in FIG. 20. This movement of the peeling rollers may be advantageous to accommodate fruit of significantly different sizes. In this regard, the fame structure 262 can be mounted to move toward or away from the conveyor belt as a unit. Or alternatively, the peeling rollers 260A and 260B can be mounted to be movable relative to the frame structure 262, toward and away from the conveyor belt 246. The movement of the peeling rollers relative to the conveyor belt can be automatically adjusted based on the sensed size or other parameter of the fruit being processed, for example in the manner discussed above.

In addition, the peeling rollers 260A and 260B can be configured so that the clearance gap there between can be increased or decreases. This is schematically shown in FIG. 21. This feature allows the peeling rollers to be adjusted for various parameters of the fruit being processed, such as the thickness of the skin or husk, the size of the fruit, the composition of the skin or husk, etc. The size of the clearance gap can be automatically adjusted based on the sensed size or type of fruit or other parameter of the fruit being processed, for example in the manner discussed above.

Further, rather than adjusting the clearance gap along the entire length of the peeling rollers 260A and 260B, only one end of the peeling rollers may be movable relative to each other. This can be either the proximal or the distal ends of the peeling rollers. Alternatively, both ends of the peeling rollers may be independently adjustable relative to each other. This adjustment in the gap can be automatically performed based on information from the sensor 230 or other sensor employed.

The peeling rollers 260 can be of various configurations. For example, as shown in FIG. 22 longitudinal ridges 310 may extend along the length of the rollers. The tips of the ridges can be blunt, rounded, sharp, etc. Also, the number of the ridges 310 and their heights may vary depending on various parameters of the fruit being processed. Such parameters may include, for example, the type of fruit being processed, the size of the fruit being processed, the ripeness or maturity of the fruit being processed, etcetera.

Rather than being in straight lines along the length of the peeling rollers 260, the ridges 310 may spiral about the exterior of the rollers. Also, as another example rather than being continuous ridges, the ridges may be formed in segments, on whether in a straight row or in a spiral pattern.

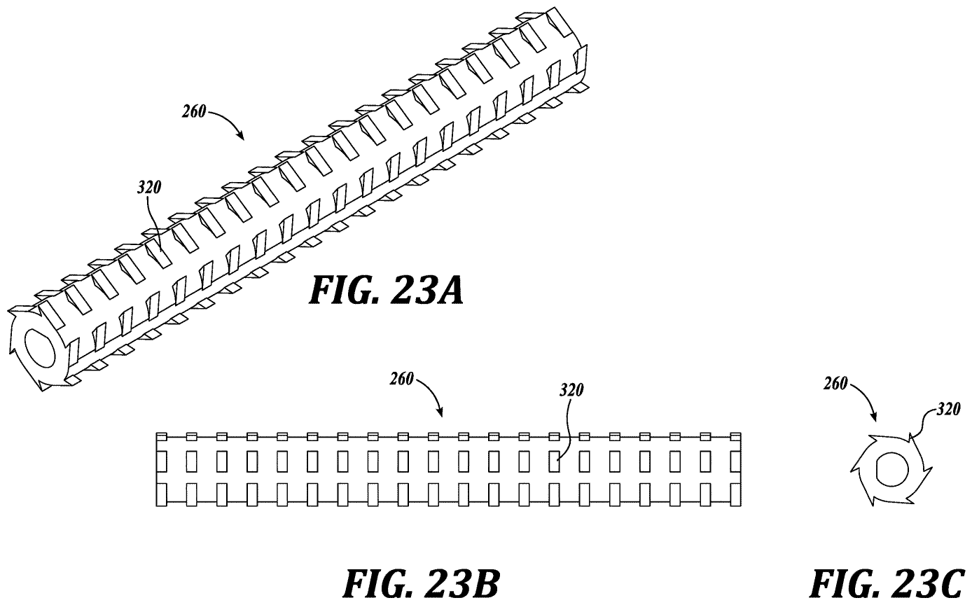

As the further alternative, teeth 320 may be positioned along the length of the rollers 260, for example as shown in FIGS. 23A, 23B, and 23C. The teeth 320 are shown as separate members uniformly spaced apart along the length of the rollers, however the teeth can be non-uniformly spaced along the length of the rollers 260 or even substantially continuous along the length of the rollers.

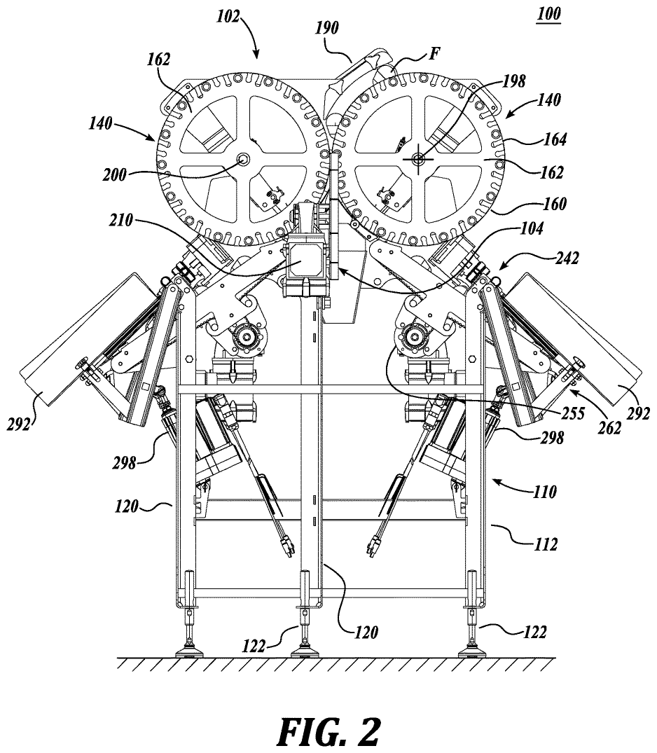

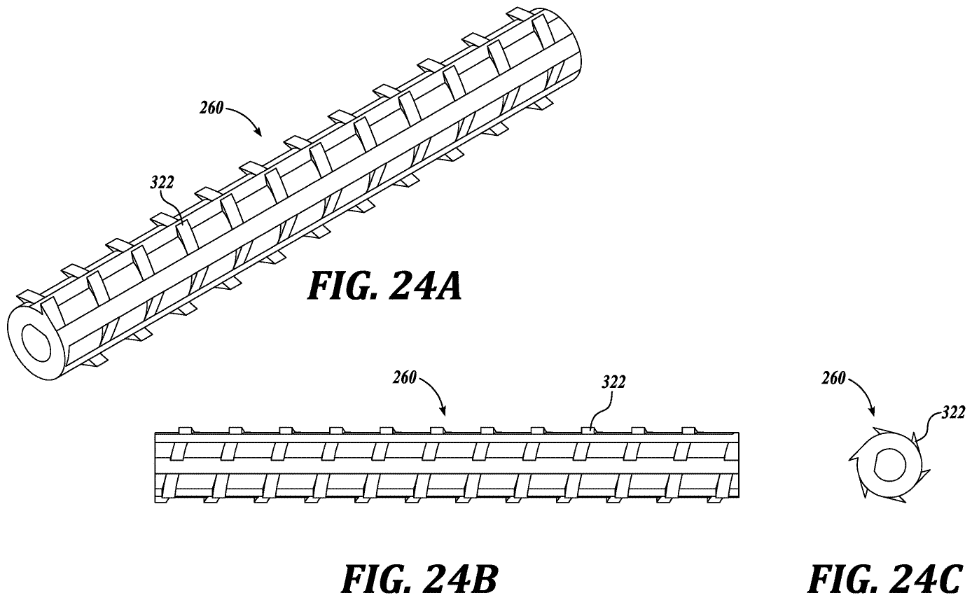

As another alternative, FIGS. 24A, 24B, and 24C, show the use of teeth 322 that are similar to teeth 320, but are canted relative to the length of the rollers, as perhaps best shown in FIG. 2B.

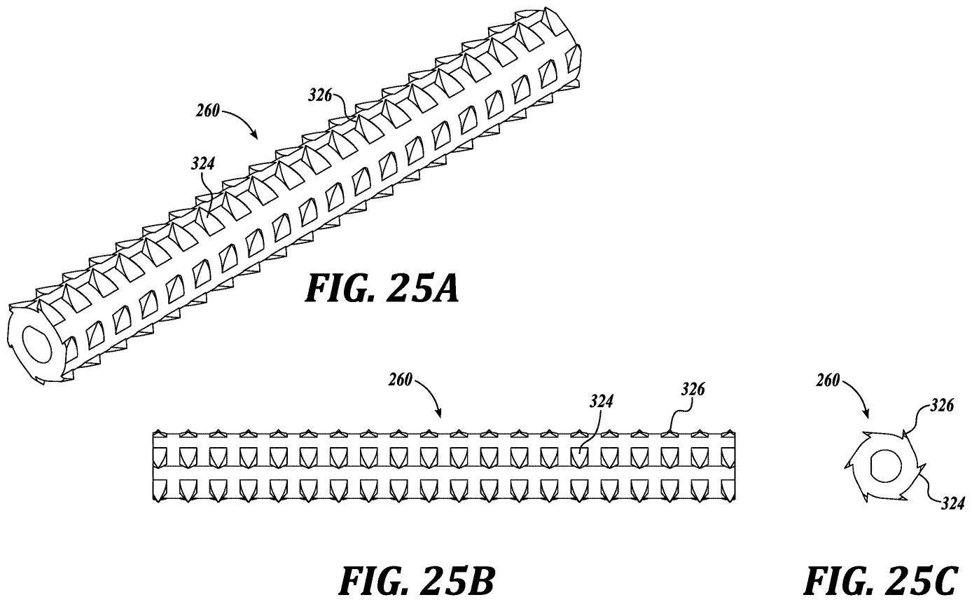

FIGS. 25A, 25B, and 25C show another configuration of the peeling rollers 260 having teeth 324 with sharpened tips 326 that are designed to aggressively engage the skin or husk of the fruit. The teeth 324 are shown as being disposed in straight rows, however such teeth may be disposed in curved or spiral rows. Further, the teeth can be canted with respect to the length of the peeling rollers.

The foregoing are not intended to be exclusive or exhaustive of the configuration of the peeling rollers. Other configurations for the peeling rollers are possible. For example, the exterior surface of the peeling rollers maybe in the form of spikes extending radially therefrom or the exterior surface Of the peeling rollers may be knurled.

Regardless of the configuration of the peeling rollers, as noted above, applicant has found that the use of a pair of longitudinal spaced apart peeling rollers causes the peeling rollers to rotate oblong fruit to be aligned with the peeling rollers as the fruit is advanced by the conveyor. This is schematically shown in FIG. 26.

Although the peeling rollers 260A and 260B are shown as longitudinal rollers, the peeling rollers can be of other shapes, for example the peeling rollers can be generally spherical or cylindrical, but with a concave section for receiving the fruit therein. These peeling rollers can be configured to pinch and remove the skin in the manner of the rollers 260A and 260B discussed above. Alternatively, The peeling rollers can be configured to abrade the skin from the fruit half.

While illustrative embodiments have been illustrated and described, it will be appreciated that various changes can be made therein without departing from the spirit and scope of the invention.

As one example, as shown in FIG. 7, the profile of the gripper structure segment 170 can be configured so that the gripper structure may more easily conform to the shape of the fruit in the direction away from the faceplate, or in other words toward the center of the groove or depression 152 formed by the gripping structure. In this regard, the thickness of the segment 170 can be decreased in the direction away from the mounting button 176.

As another example, rather than using wheel assemblies 140, the gripping structure for gripping the hold the fruit during slicing can be in the form of belts that ride on a surface or other support to converge towards each other to thereby hold the fruit between the two converged belts while the fruit is being sliced. The belts can be configured to form a longitudinal depression or groove extending along the belts to hold the fruit therein. Once the fruit is sliced, the belts can continue to move the fruit halves to a pitting device to remove the pit in a manner that is the same or similar to that discussed above.

The embodiments of the invention in which an exclusive property or privilege is claimed are defined as follows:

1. An apparatus for processing fruit having a pulp disposed within a husk and a pit disposed in the pulp, the apparatus comprising:
a. spaced apart contoured gripping surfaces converging toward each other to receive and hold a fruit there between;
b. a cutting device cutting the fruit through the pit into two halves while held by the gripping surfaces;
c. a sensor sensing at least one physical parameter of the fruit half related to the location of the pit in the fruit half; and
d. an ejector for ejecting the pit from the fruit half based on the sensed at least one physical parameter of the fruit half.

2. The apparatus of claim 1, wherein the gripping surfaces are configured to define a groove to receive the fruit therein.

3. The apparatus of claim 2, wherein the gripping surfaces each comprising two sections, the two sections forming complementary sections of the receiving groove.

4. The apparatus of claim 3, wherein the two sections of the gripping surfaces are spaced apart from each other.

5. The apparatus of claim 1, wherein the gripping surfaces move in a circular path.

6. The apparatus of claim 1, wherein the gripping surfaces are defined by the outer perimeter portion of a rotary wheel assembly.

7. The apparatus of claim 6, wherein the rotary wheel assembly comprising a rim structure and a gripping surface structure.

8. The apparatus of claim 7, wherein the gripping surface structure is detachably mounted on the rim structure at selective locations relative to the outer perimeter of the rim structure to alter the diameter of the gripping surface structure.

9. The apparatus of claim 1, further comprising a roller apparatus for engaging the husk to remove the husk from the pulp.

10. The apparatus of claim 9, wherein the roller apparatus comprising counter-rotating rollers that engage the husk to remove the husk from the pulp.

11. The apparatus of claim 10, wherein the rollers have textured outer surfaces to grip the husk.

12. The apparatus of claim 10, further comprising a support surface spaced apart from the rollers for supporting the fruit during removal of the husk by the rollers.

13. The apparatus of claim 12, wherein the support surface is relatively movable toward and away from the rollers.

14. The apparatus of claim 10, wherein the rollers are longitudinal in configuration to rotate about a respective longitudinal axis, with the fruit advancing toward the rollers for removal of the husk.

15. The apparatus of claim 14, further comprising a support surface spaced apart from the rollers for supporting the fruit during advancing toward the rollers and removal of the husk by the rollers.

16. The apparatus of claim 15, wherein the support surface is angled relative to the rollers to reduce the distance between the support surface and the rollers as the fruit advances towards the rollers.

17. The apparatus of claim 16, wherein the support surface is movable relatively toward and away from the at least two rollers.

18. The apparatus of claim 14, wherein the distance separating the rollers is selectively variable.

19. The apparatus of claim 1, wherein:
the sensor sensing the height of the fruit relative to the support surface; and
the distance separating the support surface from the rollers is automatically adjusted accordingly.

20. An apparatus for processing fruit having a pulp disposed within a husk and a pit disposed in the pulp, the apparatus comprising:
a. spaced apart contoured gripping surfaces converging toward each other to receive and hold a fruit there between;
b. a cutting device cutting the fruit through the pit into two halves while held by the gripping surfaces;
c. an ejector for ejecting the pit from the fruit half; and
d. a roller apparatus for engaging the husk to remove the husk from the pulp.
